(19) United States
(12) Patent Application Publication
(10) Pub. No.: US 2018/0001188 A1
(43) Pub. Date: Jan. 4, 2018

(54) CONTROLLER FOR COMPUTER ENTERTAINMENT SYSTEM

(71) Applicant: MVR Global Limited, Ruislip, Middlesex (GB)

(72) Inventor: Sachin Patel, Harrow, Middlesex (GB)

(73) Assignee: MVR Global Limited, Ruislip, Middlesex (GB)

(21) Appl. No.: 15/543,183

(22) PCT Filed: Jan. 6, 2016
(86) PCT No.: PCT/GB2016/050023

§ 371 Date: Jul. 12, 2017

(30) Foreign Application Priority Data
Jan. 14, 2015 (GB) 1500545.7

(51) Int. Cl. A63F 13/211; A63F 13/428; A63F 13/323; A63F 13/5255; A63F 13/235

(52) U.S. Cl. CPC A63F 13/211; A63F 13/5255; A63F 13/235; A63F 13/323; A63F 13/428

(57) ABSTRACT

A controller for a computer entertainment system including a control box (104) for executing and running a computer game and causing game footage to be displayed on a screen (510—FIG. 3), said control box (104) being configured to receive control signals representative of user manipulation of said game and dynamically adjust said game footage accordingly; said controller comprising a hand-held gamepad (102) and an inertial sensor (106), separate from and configured for data communication with, said gamepad (102); said hand-held gamepad (102) comprising at least one control input device and including a processor (114—FIG. 5) for generating control signals for manipulating a game running on said control box (104) in response to user manipulation of said at least one control input device and causing said control signals to be transmitted to said control box (104); said inertial sensor (106) being configured to be mounted in or on a user-worn garment such that user movement causes corresponding movement of said inertial sensor (106); said processor (114—FIG. 5) being further configured to receive signals from said inertial sensor (106) representative of user movement, convert said signals into control signals for manipulating said computer game, said control signals being of the same format as control signals generated in response to user manipulation of a respective control input device, and cause said control signals to be transmitted to said control box (104).

This invention relates generally to a controller for a computer entertainment system compatible with a head-mounted display and, more particularly, to a controller for enabling user manipulation of such a system.

Head-mounted displays of various types are known, and typically comprise a video display screen and a means of mounting the display screen in front of a wearer's eyes. In recent years, increasing development within the gaming industry has resulted in systems which provide a user with a virtual reality experience by including a head-mounted display wherein the game footage is displayed on the display screen in front of, and close to, the wearer's eyes, with the object of fully immersing the user in the virtual reality world generated as the game is played.

Fully integrated virtual reality gaming systems have been developed, such as Oculus Rift, wherein the video display screen is built into the headset, and a separate control box is provided for control of bespoke games. Such integrated systems are costly, and do not provide a user with the ability to obtain a virtual reality experience in respect of existing computer games.

In contrast, International patent application number WO2014/108693 describes a more cost-effective and flexible solution comprising a head-mounted display including attachment means for removably securing a display screen therein such that it is located in front of the user's eyes, in use; and, optionally, speakers located in the headset and located near the wearer's ears, in use, for outputting game sounds. The video display screen may, for example, be provided in the form of a stand-alone mobile phone or portable gaming device. However, in alternative embodiments, the video display screen may be configured to receive (wirelessly or otherwise) and display video data representative of game progression from the main game control box.

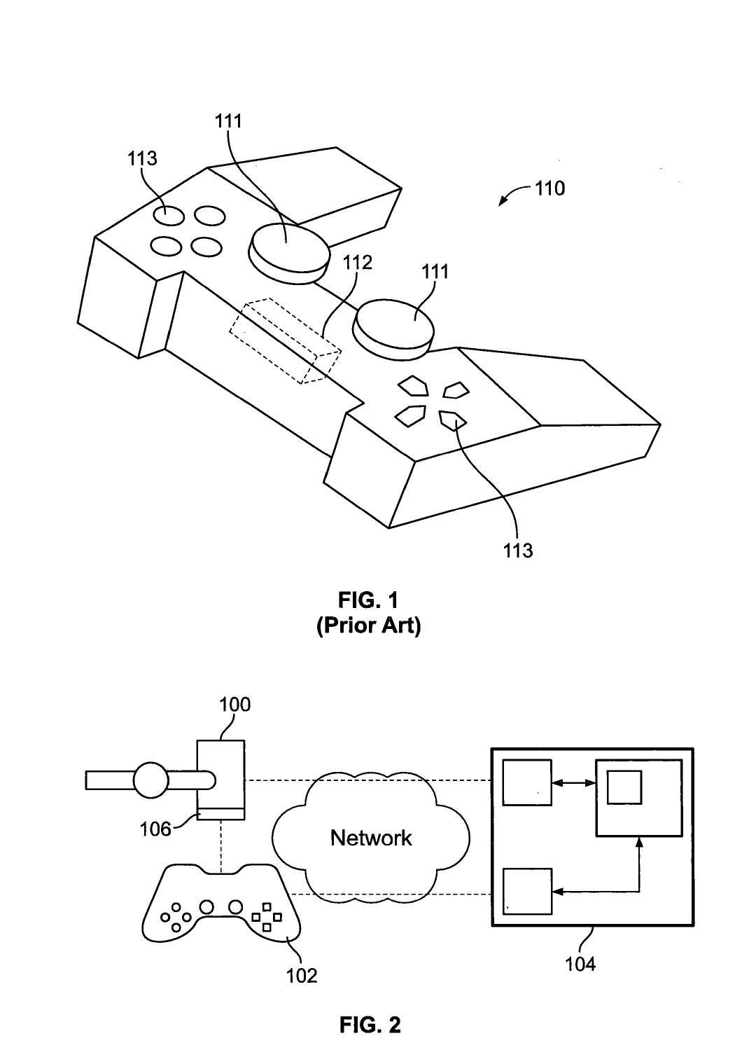

In all cases, however, a separate, hand-held controller is required to be provided to enable the user to manipulate all aspects of the game. A typical controller for this purpose is illustrated in FIG. 1 of the drawings and comprises a gamepad 110 including conventional control input devices, such as joysticks 111 and buttons 113. The gamepad 110 further comprises an inertial sensor 112, which is typically an accelerometer, that produces signals in response to the position, motion, orientation or change in orientation of the gamepad 110. In general, signals from the inertial sensor 112 are used to generate position and orientation data for the gamepad 110, and such data may be used to calculate many physical aspects of the gamepad 110, such as for example, its acceleration and velocity, along any axis, its tilt, pitch, yaw, roll, as well as any telemetry points of the gamepad 110. Thus, the manner in which a user physically moves the gamepad 110 can be used as another input for controlling the game. For example, one of the joysticks 111 may be used to move the player's avatar through the game, whilst the movement of the gamepad 110 (i.e. data from the inertial sensor 112) may be used to selectively alter the player's field of view within the game footage (e.g. ‘looking’ left and right within a scene). In some gaming systems, the user is able to select which aspects of the game are controlled by each of the control input devices, in accordance with personal preference.

In a virtual reality gaming environment, the separation of the control inputs from the game footage in this manner can detract from the user's overall virtual reality experience, and it would be desirable, therefore, to provide a system of this type in which the control inputs of the game are more intuitive from the user's perspective. Systems exist in which an inertial sensor is provided on, for example, the head-mounted display and configured to transmit signals representative of a user's head to the control box as an alternative control input for manipulating an aspect of the game. For example, US 2014/0364209 describes a virtual reality game system having a head mounted display and a hand-held gamepad. The hand-held gamepad includes at least one control input device, manipulation of which causes corresponding control signals to be generated and transmitted to the game control box, for example, to cause the player's avatar to move around within the game scene and/or effect operations such as shooting. An inertial sensor is provided on the head-mounted display for generating signals corresponding to movement of the user's head, and such signals are transmitted to the game control box and converted into control signals to change the players field of view of the game scene. By way of example, the player may turn their head to the left causing a corresponding signal to be sent from the inertial sensor to the game control box. The processor in the control box converts the movement signal to a control signal and causes the game player's field of view, as displayed on the screen, to change as if their avatar was looking to its left.

However, in order for such systems to work, the processor in the control box itself, i.e. the main game control unit, must be configured to receive and process the inertial sensor signals in order to cause associated manipulation of the game. Thus, the resultant system is an integrated system, pre-programmed to include all control features. On the other hand, if a user wishes to employ a head-mounted display with an existing system configured only to respond to a hand-held gamepad control input, there is currently no facility to enable them to experience the full virtual reality game experience offered by inertial sensor technology on the head mounted display itself.

Aspects of the present invention seek to address at least some of these issues and, in accordance with an aspect of the present invention, there is provided a controller for a computer entertainment system including a control box for executing and running a computer game and causing game footage to be displayed on a screen, said control box being configured to receive control signals representative of user manipulation of said game and dynamically adjust said game footage accordingly; said controller comprising a hand-held gamepad and an inertial sensor, separate from and configured for data communication with, said gamepad; said hand-held gamepad comprising at least one control input device and including a processor for generating control signals for manipulating a game running on said control box in response to user manipulation of said at least one control input device and causing said control signals to be transmitted to said control box; said inertial sensor being configured to be mounted in or on a user-worn garment such that user movement causes corresponding movement of said inertial sensor; said processor being further configured to receive signals from said inertial sensor representative of user movement, convert said signals into control signals for manipulating said computer game, said control signals being of the same format as control signals generated in response to user manipulation of a respective control input device, and cause said control signals to be transmitted to said control box.

The gamepad may be communicably coupled, wired or wirelessly, to said control box, wherein said processor is configured to transmit said control signals directly to said control box.

The controller may include a remote display application to which said gamepad is communicably coupled, wired or wirelessly, said remote display application being configured to receive said control signals from said gamepad and transmit said control signals, or data representative thereof, to said control box. The remote display application may be configured to receive game data from said control box and transmit said game data, or signals representative thereof, to said screen for display. The remote display application may be configured for data communication with said control box via wi fi communication.

The controller may comprise a hard wired data connection between said inertial sensor and a receiver in or on said gamepad. Alternatively, or in addition, said inertial sensor may include a wireless transmitter for transmitting signals therefrom, and said gamepad may include a wireless receiver for receiving said signals and transmitting them to said processor.

In one exemplary embodiment, the gamepad may include a calibration function for setting an initial inertial sensor reading to a predetermined level representative of a normal or central position associated with said user. In this case, the gamepad may include a control input device operable by said user in order to cause said calibration function to be effected.

In some aspects of the invention, the controller may include a selection function for enabling a user to select a control input device on said gamepad in respect of which said inertial sensor signals will be used to generate respective control signals. In this case, the selection function may be facilitated by one or more control input devices provided on said gamepad and selectively operable by said user.

The inertial sensor may comprise a gyroscope and/or accelerometer.

In accordance with exemplary embodiments of the invention, the controller may comprise a plurality of inertial sensors, each configured to be mounted in or on a user-worn garment, at different locations, such that user movement causes corresponding movement of a respective inertial sensor; said processor being further configured to receive signals from said inertial sensor representative of user movement and data representative of the inertial sensor from which said signals originate, convert said signals into control signals for manipulating said computer game, and cause said control signals to be transmitted to said control box.

These and other aspects of the present invention will be apparent from the following specific description, in which embodiments of the present invention are described, by way of examples only, and with reference to the accompanying drawings, in which:

FIG. 1 is a schematic perspective view of a game controller according to the prior art;

FIG. 2 is a schematic block diagram of principal aspects of a computer entertainment system including a controller according to an exemplary embodiment of the present invention;

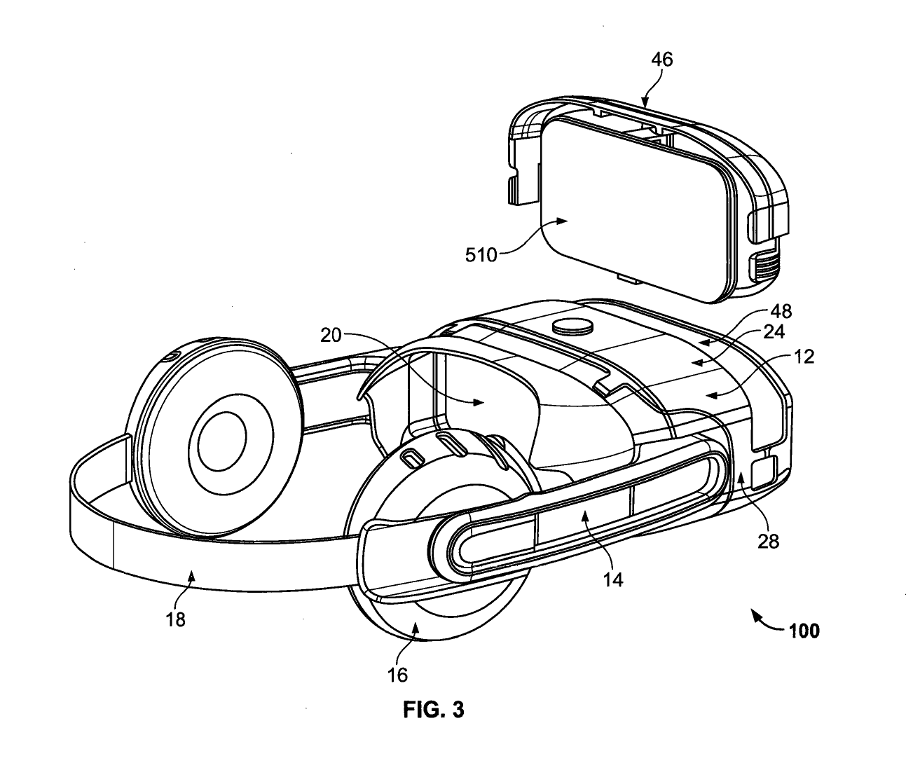

FIG. 3 is a schematic perspective view of a head mounted display device for use in the computer entertainment system of FIG. 2;

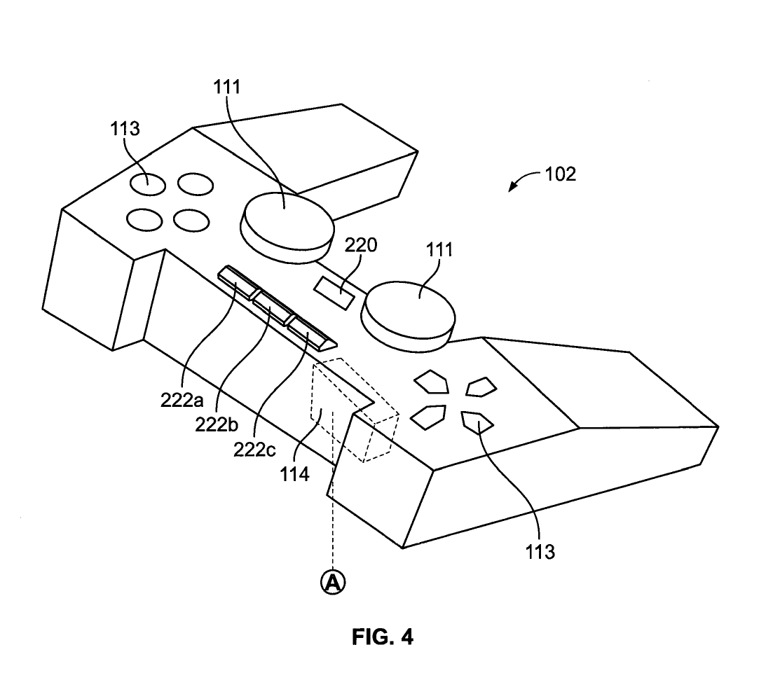

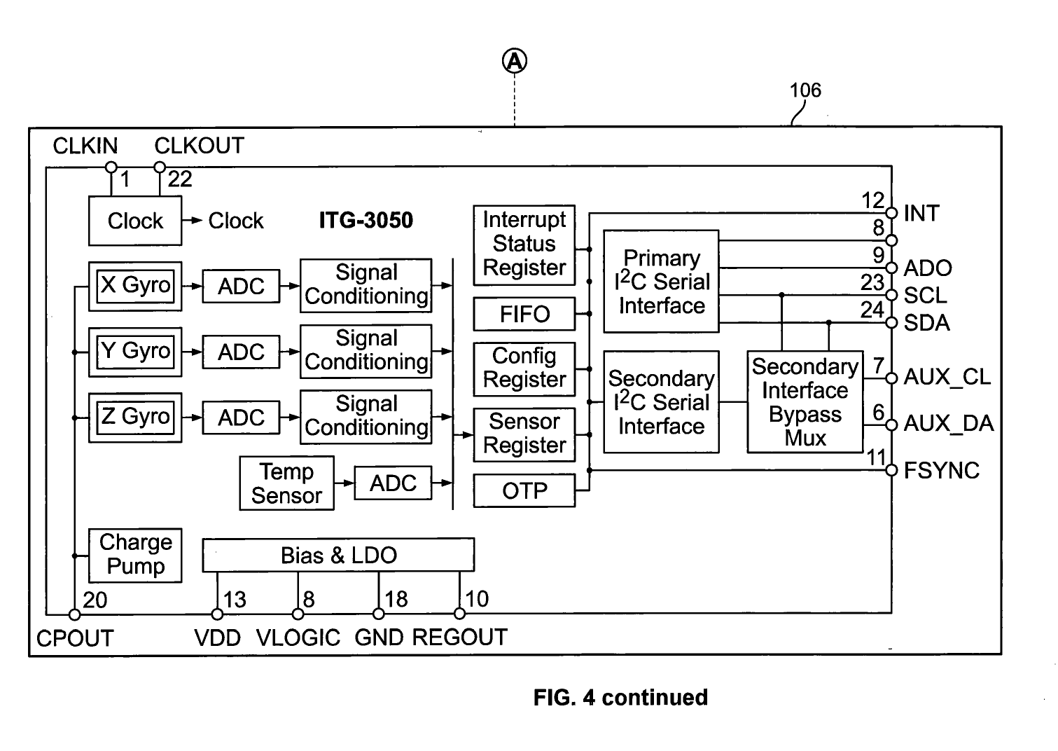

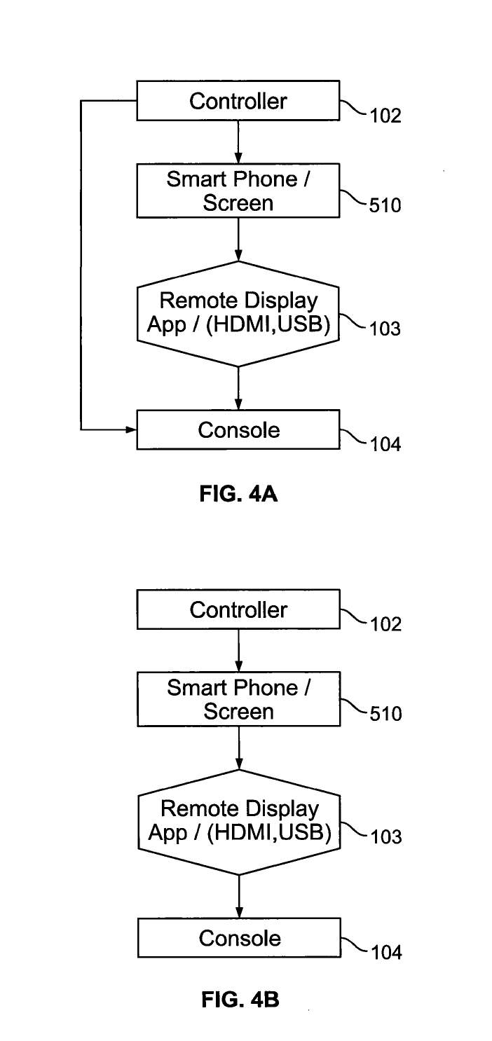

FIG. 4 is a schematic diagram illustrating the principal aspects of a controller according to an exemplary embodiment of the present invention;

FIG. 4A is a schematic diagram illustrating a method of operation of a controller according to a first exemplary embodiment of the present invention;

FIG. 4B is a schematic diagram illustrating a method of operation of a controller according to a second exemplary embodiment of the present invention;

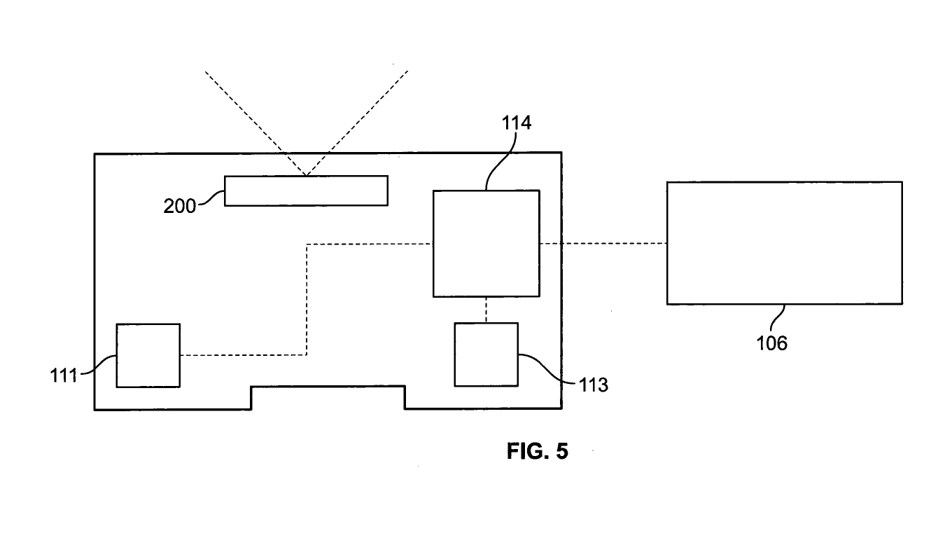

FIG. 5 is a schematic block diagram illustrating features of the controller or FIG. 4.

Referring to FIG. 2 of the drawings, a computer entertainment system of the type in which an exemplary embodiment of the present invention may be used comprises a head-mounted display (HMD) 100, a system control box 104, and a hand-held controller 102.

In some exemplary aspects, the system control box 104 may be provided in a conventional manner (i.e. as a games console or PC for example), with game footage being transposed, wirelessly or otherwise, onto a screen, portable (i.e. removable) or otherwise, within the HMD 100. For example, gaming systems exist wherein game footage, etc. can be transposed onto a compatible portable device such as a mobile phone or hand-held gaming console, including an integrated screen, and the HMD may be configured such that the portable device can be mounted therein, for use. The screen within the HMD 100 has associated therewith a mobile application, hereinafter referred to as a ‘smartphone remote display app’ 103 (see FIGS. 4A and 4B hereinafter). If the screen is provided in the form of a mobile computing device, such as a smartphone, tablet, or smart games console, the app may be provided within the device itself. However, if the screen is a passive device, the app may be running on a separate device, such as a smart phone, communicably coupled (wired or wirelessly) to the screen. The remote display app 103 is a smartphone application configured to connect (wirelessly) to a console/PC control box, and cause graphics from the console/PC control box to be displayed on a mobile computing device, such as a smartphone or tablet display. Examples of such apps will be known to a person skilled in the art, and it will be appreciated that the remote display app offers, wirelessly, the equivalent functionality of a hard wired connection (HDMi or USB) connection between the console/PC control box and the mobile computing device.

Referring to FIG. 3 of the drawings, an exemplary HMD 100 comprises a main housing 12 rigid side members 14, speakers 16, and an adjustable flexible band 18.

The housing 12 has a rear open end 20 for fitting over the eyes of a wearer, a front end 22, a top 24, a bottom 26 and two lateral sides 28, 30. In use, the housing 12 extends outwardly from the front of the wearer's face. Rigid side members 14 are attached to the housing 12, one side member being attached to each lateral side 28, 30, and each side member extending rearwardly, that is, in the direction of the open end 20 and substantially parallel with the lateral sides 28, 30. In use, the rigid side members 14 pass either side of the wearer's head, so that the device fits onto the wearer's face in a similar manner to a pair of spectacles. The extent of side members between the speakers 16 and the main housing 12 may be adjustable for fitting to differently-sized heads, and the flexible band 18, which may be shortened to secure the device once it has been fitted over a wearer's head.

The main housing 12 contains a removable cassette 46, which is received within slot 48 in the top 24 of the main housing. Slot 48 extends across the entire width of the housing 12, from the lateral side 28 to the other 30. The edges of the main housing 12 are curved, so the slot in the top 24 of the housing also extends some distance down the lateral sides 28, 30 of the main housing 12. WO2014/108693 describes in detail the configuration of one suitable removable cassette of this type, although others are envisaged, and specific features thereof will not be described further herein. It will be understood by a person skilled in the art that any HMD, configured to receive a portable screen or device including an integrated screen is suitable for use in various aspects of the present invention.

The portable screen or device is secured, in use, within the removable cassette 46 and an audio cable (not shown) may be provided for connecting to the electronic audio source of the portable device, which feeds the audio signal to speakers 16 for reproduction, the cassette 46 carrying the portable device 510 may be inserted into the slot 24 of the main housing 12 such that, when the HMD 100 is secured n the user's head, over their eyes, the images on the screen of the portable device 510 are viewable.

Referring to FIG. 4 of the drawings, a controller for a computer game according to an exemplary embodiment of the present invention, comprises a hand-held controller 102 and an inertial sensor 106, which may comprise a gyroscope and/or an accelerometer. In one exemplary embodiment, the inertial sensor may comprise a single integrated circuit incorporating a gyroscope and accelerometer such as the ITG-3050 illustrated, but the present invention is not necessarily intended to be limited in this regard. The hand-held controller 102 illustrated in FIG. 4 of the drawings comprises a gamepad 102 including conventional control input devices, such as joysticks 111 and buttons 113. Referring additionally to FIG. 5 of the drawings, the gamepad 102 further comprises a processor 114 configured to receive signals representative of user-actuation/manipulation of the control input device(s) 111, 113 and convert them into control signals of a format suitable for use by the main game control box 104 in adjusting and manipulating the game as it is being played. These control signals are then transmitted, via an interface 200 to the main game control box 104 in any suitable manner. In a first exemplary embodiment, as illustrated in FIG. 4A of the drawings, the gamepad 102 is directly connected (wired or wirelessly) to the game control box 104 via, for example, USB, HDMi, Bluetooth®, or WiFi. In this case, the control signals thus generated are transmitted directly to the control box 104 from the gamepad 102, used by the control box to manipulate/update game play, and updated game data is then transmitted, via the smartphone remote display app 103 to the screen 510. In an alternative exemplary embodiment, there may be no direct connection between the gamepad 102 and the control box 104. Instead, and referring to FIG. 4B of the drawings, control signals thus generated are transmitted, via the smartphone remote display app 103, to the control box 104. The control box 104 uses the control signals to update/manipulate game play accordingly, and updated game data is transmitted, via the smartphone remote display app 103, back to the screen 510. In both FIGS. 4A and 4B of the drawings, element 103 is depicted as the smartphone remote display app (wireless connection between the console 104 and the smartphone/tablet/screen 510; or, as an alternative, HDMi or USB (hard wired connection) which provides the same functionality as that of the smartphone remote display app. It is to be understood that the present invention is not necessarily intended to be limited in this regard.

The inertial sensor 106, in this case (compared with prior art arrangements), is separate from the gamepad 102, and configured to be mounted on, for example, head-mounted display, such that the wearer's head movements can be detected and signals representative of such movement can be generated thereby. The inertial sensor is communicably coupled, either by means of a wireless connection, such as Bluetooth®, or a hard-wired connection (not shown), to said processor 114 of the hand-held controller. The inertial sensor 106 produces signals in response to the position, motion, orientation or change in orientation of the HMD. In general, signals from the inertial sensor 106 are transmitted to the processor 114 of the hand-held controller, and can be used thereby to generate position and orientation data in respect of the HMD (or whatever the inertial sensor is mounted on), and such data may be used to calculate many physical aspects thereof, such as for example, its acceleration and velocity, along any axis, its tilt, pitch, yaw, roll. This position and/or orientation data can then be converted into control signals of a format suitable for use by the main game control box 104 in adjusting and manipulating the game as it is being played, and these control signals are then transmitted to the main game control box 104 in any suitable manner. Thus, the manner in which a user physically moves their head can be used as another input for controlling the game. For example, one of the joysticks 111 may be used to move the player's avatar through the game, whilst the movement of the HMD 100 (i.e. data from the inertial sensor 112) may be used to selectively alter the player's field of view within the game footage (e.g. ‘looking’ left and right within a scene).

In some gaming systems, the user is able to select which aspects of the game are controlled by each of the control input devices, in accordance with personal preference. More particularly, in this regard, on many known gaming systems, the user is provided with an option within the game to select which control inputs control respective actions within a game. Thus, for example, their user preferences may be set such that the left analogue joystick on the gamepad controls movement through the game and their right analogue joystick or the D-pad on the gamepad controls their viewpoint within the game scenery. Thus, a gamepad for a controller according to an exemplary embodiment of the present invention may comprise a set of selection buttons 222a, 222b and 222c corresponding to each of the control inputs on the gamepad (e.g. left analogue joystick, right analogue joystick and D-pad) such that the user can select which of those control inputs the inertial sensor output is to mimic. In the above example, therefore, where the right analogue joystick is set within the game as being for controlling the user's viewpoint within the game scenery, the user can select the corresponding button on the gamepad such that the inertial sensor signals will be converted into control signals and transmitted to the games console or PC as if they were control signals resulting from user manipulation of the right analogue joystick.

The gamepad 102 illustrated in FIG. 4 of the drawings is further provided with a calibration facility, controlled by an additional button 220. The calibration facility is intended to compensate for differences in user height, gait, stance etc. Thus, at set-up, when the user has mounted the inertial sensor to their HMD, they stand in a normal fashion and press the button 220, which has the effect of calibrating the inertial sensor to zero, representative of “normal” for that particular user.

One of the principal advantages of the present invention, compared with known systems is the configuration whereby the output format from the hand-held controller is the same as it would be for a conventional hand-held controller, i.e. the main game control box does not need to be reconfigured or changed in any way to accommodate a controller according to embodiments of the present invention. Thus, the controller can be provided retrospectively in respect of games and gaming systems which are configured to operate in response to control signals from known and/or conventional controllers, whilst providing the additional benefit of improving the virtual reality experience of the user, by providing the ability to control aspects of the game by means of user head movements.

It will be apparent to a person skilled in the art, from the foregoing description, that modifications and variations can be made to the described embodiments without departing from the scope of the invention as claimed. It is to be understood that any reference above, or in the appended claims, to a gamepad is intended to cover not only a single gamepad such as that described and illustrated herein, but also a plurality of individual units that make up a controller, for example, controllers comprising a plurality of hand-held units to control right and left hand movements, such as PS Move, Wii nunchucks or Oculus Touch controllers. In this case, the processor for converting the inertial sensor signals to control signals may be provided in one or more of the individual units, and the present invention is not necessarily intended to be limited in this regard.

1. A controller for a computer entertainment system including a control box for executing and running a computer game and causing game footage to be displayed on a screen, said control box being configured to receive control signals representative of user manipulation of said game and dynamically adjust said game footage accordingly;
said controller comprising a hand-held gamepad and an inertial sensor, separate from and configured for data communication with, said gamepad;
said hand-held gamepad comprising at least one control input device and including a processor for generating control signals for manipulating a game running on said control box in response to user manipulation of said at least one control input device and causing said control signals to be transmitted to said control box;
said inertial sensor being configured to be mounted in or on a user-worn garment such that user movement causes corresponding movement of said inertial sensor; and
said processor being further configured to receive signals from said inertial sensor representative of user movement, convert said signals into control signals for manipulating said computer game, said control signals being of the same format as control signals generated in response to user manipulation of a respective control input device, and cause said control signals to be transmitted to said control box.

2. A controller according to claim 1, wherein said gamepad is communicably coupled, wired or wirelessly, to said control box, wherein said processor is configured to transmit said control signals directly to said control box.

3. A controller according to claim 1, including a remote display application to which said gamepad is communicably coupled, wired or wirelessly, said remote display application being configured to receive said control signals from said gamepad and transmit said control signals, or data representative thereof, to said control box.

4. A controller according to claim 3, wherein said remote display application is configured to receive game data from said control box and transmit said game data, or signals representative thereof, to said screen for display.

5. A controller according to claim 4, wherein said remote display application is configured for data communication with said control box via wi fi communication.

6. A controller according to claim 1, comprising a hard wired data connection between said inertial sensor and a receiver in or on said gamepad.

7. A controller according to claim 1, wherein said inertial sensor includes a wireless transmitter for transmitting signals therefrom, and said gamepad includes a wireless receiver for receiving said signals and transmitting them to said processor.

8. A controller according to claim 1, including a calibration function for setting an initial inertial sensor reading to a predetermined level representative of a normal or central position associated with said user.

9. A controller according to claim 8, wherein said gamepad includes a control input device operable by said user in order to cause said calibration function to be effected.

10. A controller according to claim 1, including a selection function for enabling a user to select a control input device on said gamepad in respect of which said inertial sensor signals will be used to generate respective control signals.

11. A controller according to claim 10, wherein said selection function is facilitated by one or more control input devices provided on said gamepad and selectively operable by said user.

12. A controller according to claim 1, wherein said inertial sensor comprises a gyroscope and/or accelerometer.

13. A controller according to claim 1, further comprising a plurality of inertial sensors, each configured to be mounted in or on a user-worn garment, at different locations, such that user movement causes corresponding movement of a respective inertial sensor; and
said processor being further configured to receive signals from said inertial sensor representative of user movement and data representative of the inertial sensor from which said signals originate, convert said signals into control signals for manipulating said computer game, and cause said control signals to be transmitted to said control box.

14. A controller according to claim 1, wherein said gamepad comprises a plurality of individual units.

15. (canceled)

16. A controller according to claim 4, wherein said remote display application is configured for data communication with said control box via wi fi communication.
